(19) United States
(12) Patent Application Publication
(10) Pub. No.: US 2007/0157434 A1
(43) Pub. Date: Jul. 12, 2007

(54) Height-adjustable hinge for a liquid crystal display

(76) Inventors: Sheng-Nan Lu, Shulin City (TW); Yao-Tsung Chan, Shulin City (TW)

Correspondence Address: HERSHKOVITZ & ASSOCIATES, 2845 DUKE STREET, ALEXANDRIA, VA, 22314, US

(21) Appl. No.: 11/404,827

(22) Filed: Apr. 17, 2006

(30) Foreign Application Priority Data
Jan. 6, 2006 (TW) 095200363

(51) Int. Cl. E05D 15/00

(52) U.S. Cl. 16/369

(57) ABSTRACT

A hinge includes a bracket adapted to be securely connected to a support, a base adapted to securely attach to a display and having two upright and opposite extensions each having a pivot hole and two shafts, a fixing seat securely connected to the base and having through holes respectively defined in a bottom portion of the fixing seat, a first arm having two first ends pivotally connected to first apertures of the fixing seat and second ends pivotally connected to the bracket and a second arm having two first ends pivotally connected to second apertures of the fixing seat and second ends pivotally connected to the bracket such that the base is pivotal relative to the bracket and the display attached to the base is able to have height and angle adjustment.

### BACKGROUND OF THE INVENTION

1. Field of the Invention

The present invention relates to a hinge, and more particularly to a hinge which is able to provide height-adjustable feature to a liquid crystal display (LCD) to provide more convenient observation alternatives.

2. Description of Related Art

As well known in the art, a hinge is provided between two objects so as to provide a pivotal relationship between the two objects. Examples can be seen everywhere in our lives. A common example is the LCD of a computer, wherein the LCD pivots about a central axis so that various observation angles are provided to different operators. However, in order to protect the LCD from damage, the pivotal angle of the LCD is limited within a certain range. That is, the pivotal movement of the LCD is stopped when the LCD is pivoted to a critical angle. Consequently, if the operator is shorter than average or is a child, the mere pivotal movement of the LCD can not provide satisfactory service to meet the requirements.

To overcome the shortcomings, the present invention tends to provide an improved hinge to mitigate the aforementioned problems.

### SUMMARY OF THE INVENTION

The primary objective of the present invention is to provide an improved hinge that not only enables the display to pivot but also allows the display to be raised and lowered.

Another objective of the present invention is to provide a hinge having a positioning device so that when the display is pivoted, the positioning device is able to protect the display from damage through excessive travel.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the hinge of the present invention in assembly;

FIG. 2 is an exploded perspective view of the hinge of the present invention;

FIGS. 3 and 4 are side views showing that the hinge of the present invention is raised and lowered;

FIG. 5 is a side view showing that the hinge of the present invention is pivoted so as to change altitude of a display attached to the hinge; and

FIG. 6 is a schematic view showing the application of the hinge to a back of the display.

### DETAILED DESCRIPTION OF THE PREFERRED EMBODIMENT

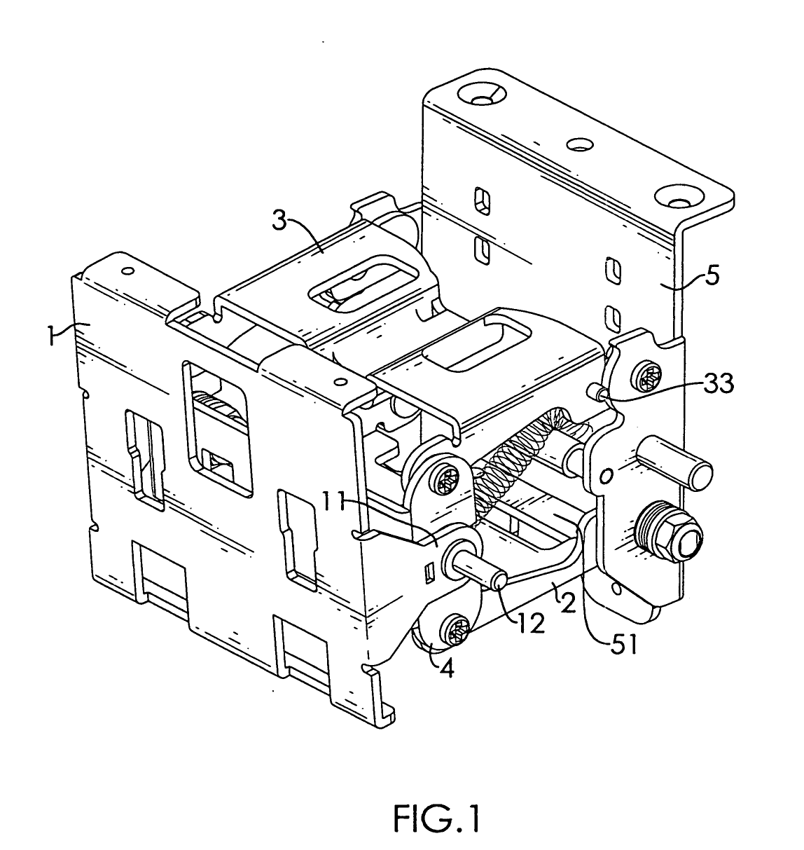

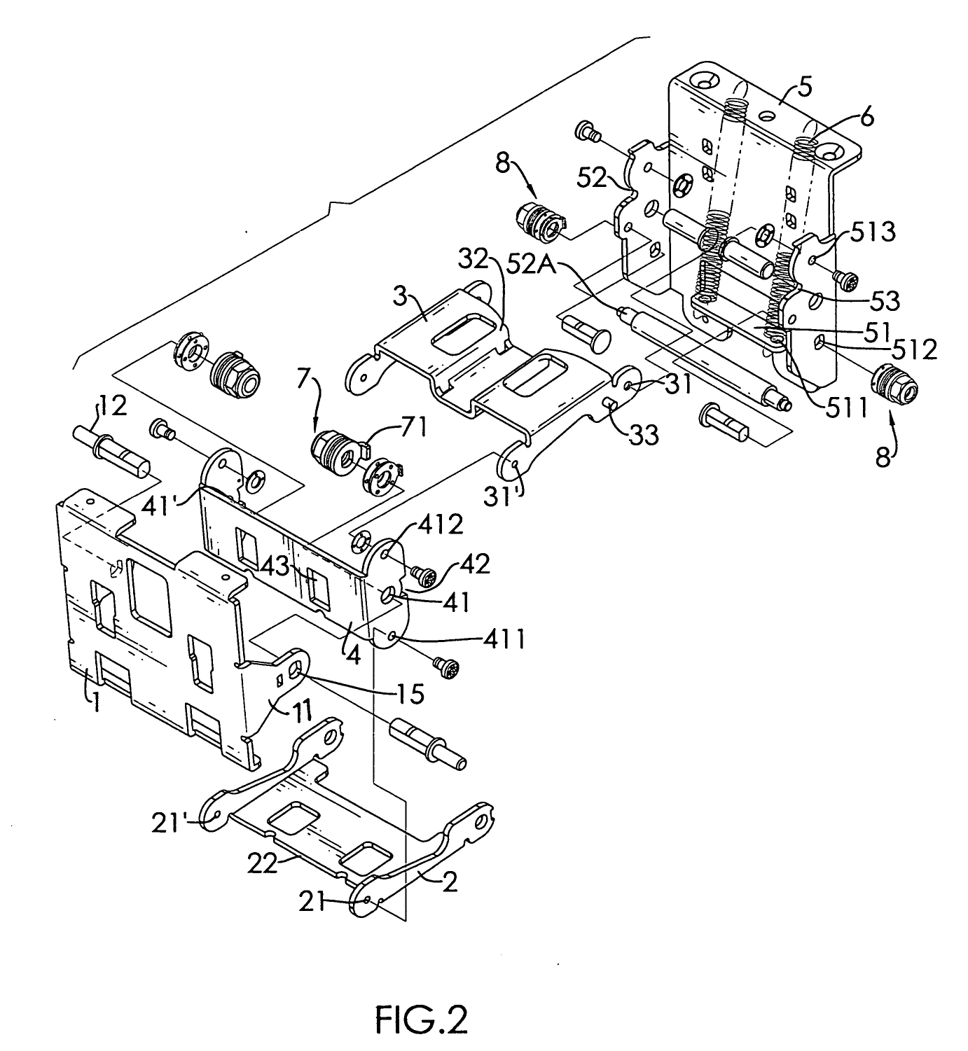

With reference to FIGS. 1 and 2, the hinge in accordance with the present invention includes a base (1), a first arm (2), a second arm (3), a fixing seat (4) and a bracket (5).

The base (1) adapted to be attached to a back of a display includes two upright extensions (11) each with a first hole (15) aligned with the first hole (15) of the other upright extension (11) and a shaft (12) securely extended into the two first holes (15) of the two upright extensions (11).

The first arm (2) is composed of two arms each having a first and a second pivot hole (21,21′) defined in two distal ends thereof and a bridge (22) securely connecting the two arms together.

The second arm (3) is composed of two arms each having a first and a second pivot hole (31,31′) defined in two distal ends thereof and a bridge (32) securely connecting the two arms together. A limiting block (33) is formed on a side face of one of the two arms of the second arm (3).

The fixing seat (4) has two pairs of through holes (41,41′) defined in a side face of two opposite walls of the fixing seat (4), two positioning recesses (42) defined in an outer periphery of both of the two opposite walls of the fixing seat (4) between the two pairs of through holes (41,41′) and at least one (two are shown in this embodiment) through hole (43) defined through a bottom face of the fixing seat (4).

The bracket (5) adapted to securely attach a wall or the like includes a baffle (51) formed on a bottom face thereof and provided with two connecting holes (511) defined therein and two saddles (52,53) oppositely formed on the baffle (51) to correspond to and receive therein the limiting block (33) of the second arm (3). A washer assembly (7) is provided between the first arm (2) and the bracket (5) to connect the first arm (2) to the bracket (5). In addition, the washer assembly (7) has a positioning rod (71) formed thereon to correspond to and be received in the positioning recess (42) of the fixing seat (4) so as to limit the pivoting angle of the hinge of the present invention. A first washer assembly (8) is provided between the first arm (2) and the bracket (5). In this preferred embodiment of the present invention, the second arm (3) and the bracket (5) are connected via conventional bolt and nut combination. At least one spring (6) (two are shown) is provided between the bracket (5) and the fixing seat (4). A distal end of the spring (6) is connected to a periphery defining the through hole (43) of the fixing seat (4) and a proximal end of the spring (6) is connected to the connecting hole (511) of the baffle (51) after extending over a post (52A) such that movement of the spring (6) will not be influenced by the second arm (3).

With reference to FIG. 2 and still using FIG. 1 for reference, when the hinge of the present invention is in assembly, the two first holes (15) of the base (1) are aligned with the two through holes (41,41′) of the fixing seat (4) and then the shaft (12) is used to secure the engagement between the fixing seat (4) and the base (1) via extending through the aligned first holes (15) and he two through holes (41,41′). Further, the washer assembly (7) is provided inside the fixing seat (4) and is extended by the shaft (12). The positioning rod (71) is received in the positioning recess (42) of the fixing seat (4). The first pivot holes (21) of the first arm (2) and the second pivot holes (31) of the second arm (3) are respectively aligned with first apertures (411) defined in a bottom portion of the fixing seat (4) and second apertures (412) defined in a top portion of the fixing seat (4). A securing device such as bolt and nut combination is employed to secure the engagement among the fixing seat (4), the first arm (2) and the second arm (3). The first pivot holes (21′) of the first arm (2) and the second pivot holes (31′) of the second arm (3) are respectively aligned with first holes (512) defined in a bottom portion of the bracket (5) and second holes (513) defined in a top portion of the bracket (5). A securing device such as bolt and nut combination is employed to secure the engagement among the bracket (5), the first arm (2) and the second arm (3). The first washer assembly (8) is provided outside the bracket (5) to provide friction force between the first arm (2) and the bracket (5). After the engagement between the first arm (2) and the fixing seat (4) and between the second arm (3) and the fixing seat (4), it is noted that the first arm (2) and the second arm (3) are pivotal relative to the base (1).

Thereafter, the at least one (two are shown) spring (6) has a first end connected to the connecting hole (511) of the baffle (51) of the bracket (5) and a second end connected to the through hole (43) of the fixing seat (4). Due to the provision of the positioning rod (71) that is received in the positioning recess (42), pivotal movement of the washer assembly (7) is limited.

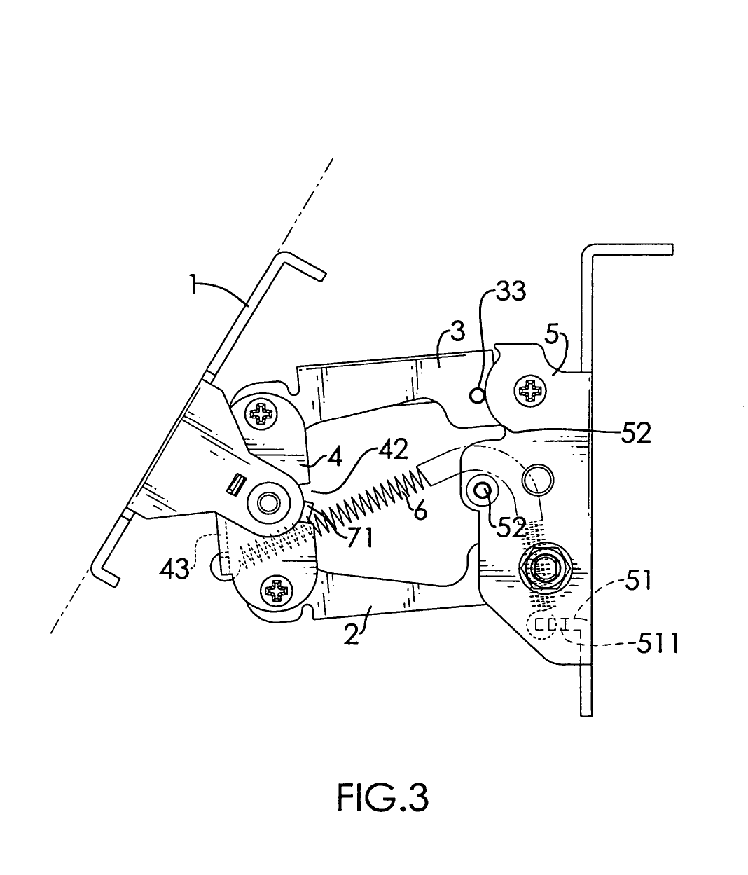

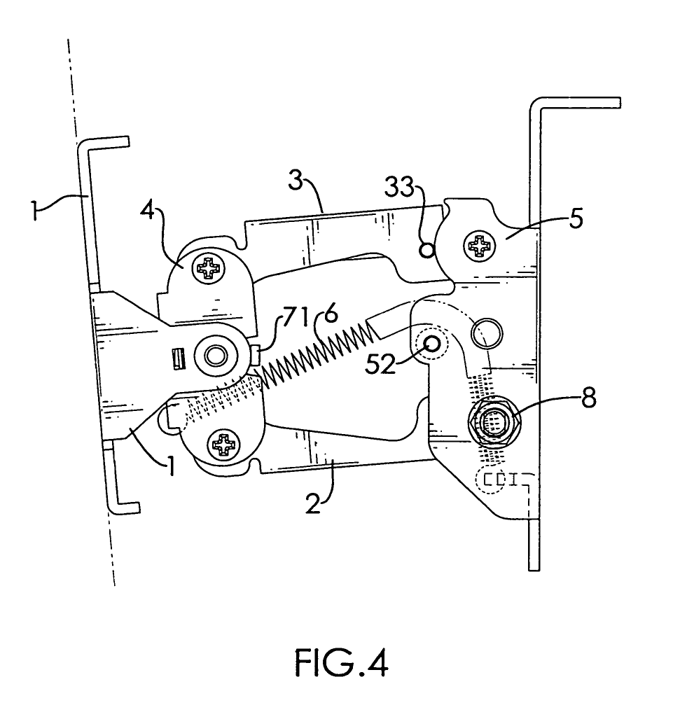

With reference to FIGS. 3 and 4, it is noted that the first arm (2) and the second arm (3) are arranged in parallel and the first arm (2) is below the second arm (3). When a display (A) securely attached to the base (1) is about to be moved upward or downward, due to the pivotal engagement between the bracket (5) and the base (1) with the first arm (2) and second arm (3) pivotally provided therebetween, the base (1) together with the display (A) is able to be moved to different altitudes. Besides, when the display (A) is moved downward, the spring (6) is extended so that when the display (A) is about to be moved upward, the recovery force stored in the spring (6) is released, which helps the operator use less effort to move the display (A) upward. Still, when the display (A) is moved upward and downward, the limiting block (33) moves back and forth in the saddle (52,53) of the bracket (5) to avoid damage to the hinge of the present invention resulted from excessive movement.

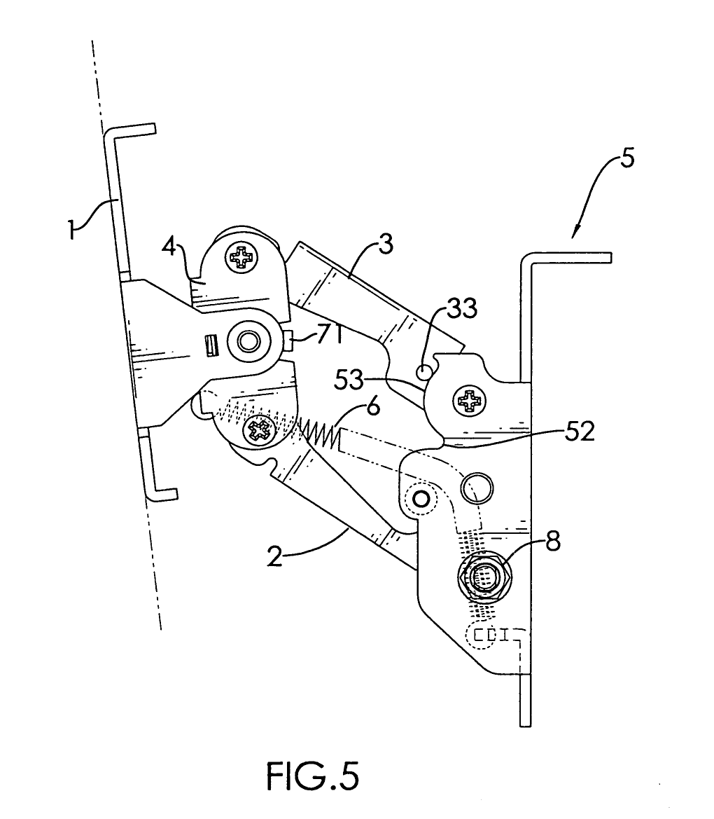

With reference to FIG. 5, again, because the bracket (5) is pivotally connected to the base (1), the bracket (5) together with the display (A) is able to pivot relative to the base (1) such that the display (A) is able to have angle adjustment ability. While the display (A) angle is being adjusted, the positioning rod (71) moves between the two positioning recesses (42), which limits the angle adjustment of the display (A) so that the display (A) is protected from damage.

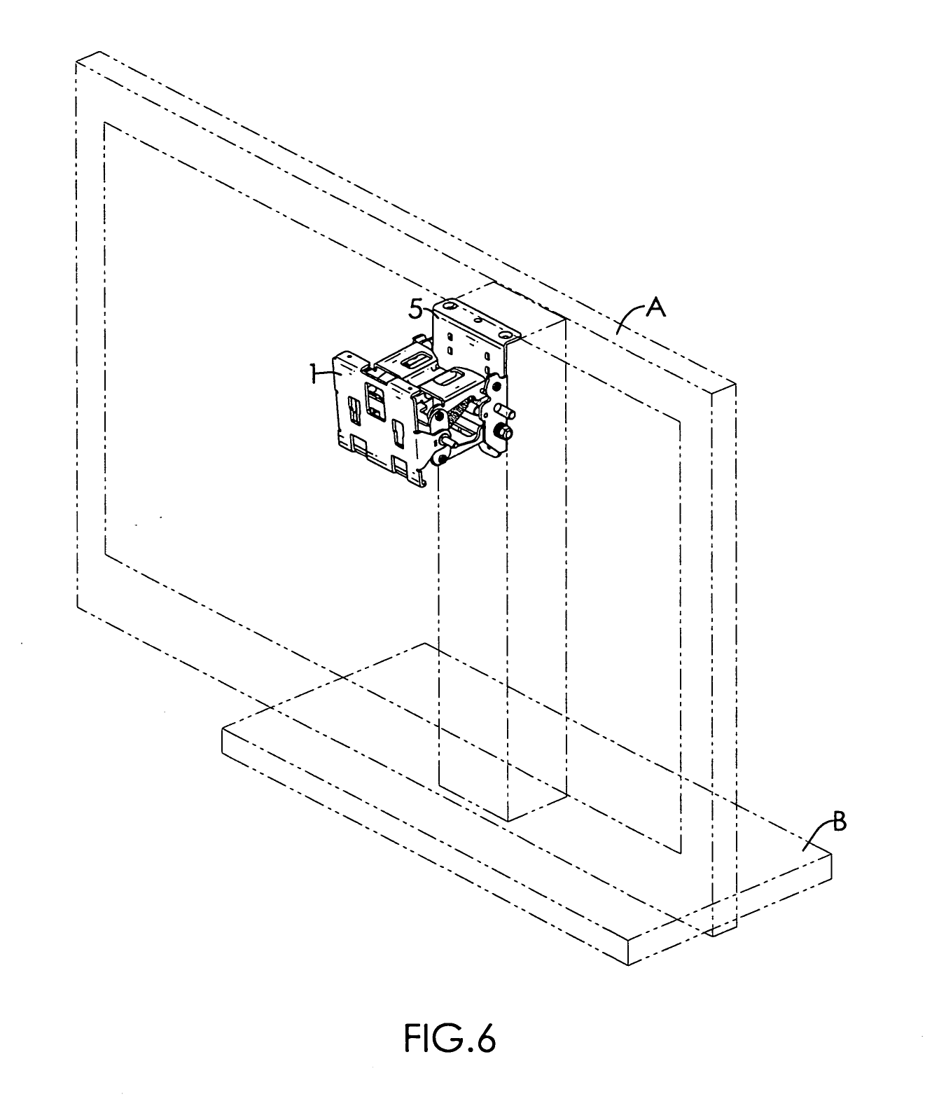

With reference to FIG. 6, it is noted that when the hinge of the present invention is in application to support the display (A), the bracket (5) is securely mounted on a support (not numbered but shown in dotted lines). The first washer assembly (7) may be sandwiched only by one upright extension (11) and one side face of the second arm (3). The second washer assembly (8) may be provided only on one side face of the bracket (5) to provide the necessary friction to support the display (A) attached to the base (1).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge comprising:
a bracket adapted to be securely connected to a support;
a base adapted to securely attach to a display and having two upright and opposite extensions each having a pivot hole and two shafts;
a fixing seat securely connected to the base and having through holes respectively defined in a bottom portion of the fixing seat;
a first arm having two first ends pivotally connected to first apertures of the fixing seat and second ends pivotally connected to the bracket;
a second arm having two first ends pivotally connected to second apertures of the fixing seat and second ends pivotally connected to the bracket such that the base is pivotal relative to the bracket and the display attached to the base is able to have height and angle adjustment.

2. The hinge as claimed in claim 1 further comprising at least one spring having a first end securely connected to the bracket and a second end securely connected to the fixing seat to provide a recovery force to the base when the base is moving from a lower position to an upper position.

3. The hinge as claimed in claim 2, wherein the bracket further has a baffle formed on a bottom face thereof and having a connecting hole defined to receive therein the first end of the at least one spring and the fixing seat has a through hole defined through a bottom thereof to securely receive therein the second end of the at least one spring.

4. The hinge as claimed in claim 3, wherein a post is provided inside the bracket so that the second end of the at least one spring is extended over the post to connect to the fixing seat.

5. The hinge as claimed in claim 4, wherein at least one saddle is provided in the bracket to receive therein a limiting block to prevent excessive movement.
